(19) United States
(12) Patent Application Publication
(10) Pub. No.: US 2023/0032724 A1
(43) Pub. Date: Feb. 2, 2023

(54) METHOD FOR MANUFACTURING GLASS SUBSTRATE AND GLASS SUBSTRATE

(71) Applicant: NIPPON ELECTRIC GLASS CO., LTD., Otsu-shi, Shiga (JP)

(72) Inventors: Atsuki SAITO, Otsu-shi, Shiga (JP); Naotoshi INAYAMA, Otsu-shi, Shiga (JP); Shunsuke MIYATA, Otsu-shi, Shiga (JP)

(73) Assignee: NIPPON ELECTRIC GLASS CO., LTD., Otsu-shi, Shiga (JP)

(21) Appl. No.: 17/785,497

(22) PCT Filed: Dec. 8, 2020
(86) PCT No.: PCT/JP2020/045647

§ 371 Date: Jun. 15, 2022

(30) Foreign Application Priority Data
Dec. 23, 2019 (JP) 2019-231601
May 25, 2020 (JP) 2020-090190

(51) Int. Cl. C03C 3/087

(52) U.S. Cl. CPC C03C 3/087; C03C 2203/10

(57) ABSTRACT

A method for manufacturing a glass substrate having a strain point of 680° C. or higher, the method includes: a step of melting a glass raw material; and a step of forming a molten glass, in which the forming step includes a step of cooling the molten glass such that a cooling time in a temperature range from an annealing point of the glass substrate to 500° C. is 35 seconds or more, and in a case where a cooling profile indicating a temperature change with respect to the cooling time is linearly approximated by a least-squares method in the temperature range from the annealing point of the glass substrate to 500° C., a coefficient of determination R² in the least-squares method is 0.7 or more.

### TECHNICAL FIELD

The present invention relates to a method for manufacturing a glass substrate and a glass substrate, and particularly, to a method for manufacturing a glass substrate and a glass substrate suitable for display substrates in general including an organic EL display.

### BACKGROUND ART

An electronic device such as an organic EL display is thin, excellent in moving image display, and low in power consumption, and thus is used for a display such as a television and a smartphone.

In recent years, along with the spread of a smartphone and the higher definition of a smartphone display, there is an increasing demand for a display having a particularly high pixel density. In addition, a display having higher definition is required as a display used for AR, VR, or the like, which is said to be a field with remarkable growth in the future.

A glass substrate is widely used as a substrate for mounting a TFT for driving the display or a TFT on polyimide. The glass substrate for this application is mainly required to have the following characteristics.

(1) A content of alkali metal oxide is low in order to prevent alkali ions from diffusing into a semiconductor material film-formed in a heat treatment step.

(2) The glass substrate is excellent in productivity, particularly excellent in devitrification resistance and meltability in order to reduce the cost of the glass substrate.

(3) Deformation of the glass substrate due to thermal shrinkage is small in a manufacturing step of a p-Si TFT or a-Si TFT.

(4) The glass substrate has a smooth surface suitable for the manufacturing step of a p-Si TFT or a-Si TFT.

### SUMMARY OF INVENTION

### Technical Problem

To describe the above (3) in detail, since glass after forming is generally in a quasi-equilibrium state, volume shrinkage is caused by heat treatment. This is called thermal shrinkage, which is one of major causes of a deviation in a pitch of each film formation in a step of manufacturing a display.

In order to reduce the thermal shrinkage, there are roughly two types of methods. One is a method in which a heat treatment is performed in advance before a step of manufacturing a display, and the other is a method in which a composition design with increased heat resistance of glass is performed.

A typical manufacturing method of glass in this field includes a float method and an overflow downdraw method. In the present field where both productivity and board quality are required, the manufacturing method of glass is limited to the two methods described above, but both manufacturing methods have merits and demerits as is well known.

When the float method is selected, it is easy to extend an equipment length, and it is possible to extend a cooling time, so that it is effective to reduce the thermal shrinkage, but a polishing step is required since one surface of the glass is always in contact with a Sn bath or a conveying roller. Therefore, there is a disadvantage that it is difficult to technically cope with thinning of a substrate accompanying thinning of a display device in recent years. In addition, since there is a restriction on a temperature at the time of forming, there is also a disadvantage that it is difficult to manufacture a glass composition having a high viscosity.

When the overflow downdraw method is selected, there is a restriction on the extension of the equipment length, and it is difficult to extend the cooling time as in the float method since a glass board is manufactured while being pulled in a vertical direction. However, since a film formation surface of a glass product is manufactured without any contact, a very smooth surface can be obtained. Since it is originally possible to form a smooth surface, a polishing step is not required. In addition, since a glass composition having a high viscosity can be manufactured, there is also an advantage that it is easy to design the composition to increase heat resistance of the glass.

In any of the manufacturing methods described above, it is important to perform a maximum cooling treatment on the glass during the cooling process so as to reduce a thermal shrinkage. In particular, in the case of the overflow downdraw method where the cooling time is limited, the cooling time is shortened, so that it is very important how to realize an efficient cooling profile. In a case where a cooling profile which is more efficient and is effective in a short time is selected in the float method, a production amount per unit time can be increased by that amount, and therefore, the effect is very large in this field where cost reduction is required.

In view of the above, an object of the present invention is to provide a cooling profile that is effective when manufacturing a glass substrate.

### Solution to Problem

As a result of repeating various experiments, the present inventors have found that how to cool, even for a short time, has a great influence on a thermal shrinkage. It is also found that the above technical problems can be solved by appropriately controlling the cooling profile, and propose the present invention.

A method for manufacturing a glass substrate of the present invention is a method for manufacturing a glass substrate having a strain point of 680° C. or higher. The method includes: a step of melting a glass raw material; and a step of forming molten glass. The forming step includes a step of cooling the molten glass such that a cooling time in a temperature range from an annealing point of the glass substrate to 500° C. is 35 seconds or more, and in a case where a cooling profile indicating a temperature change with respect to the cooling time is linearly approximated by a least-squares method in the temperature range from the annealing point of the glass substrate to 500° C., a coefficient of determination R² in the least-squares method is 0.7 or more. Here, the “annealing point” refers to a value measured based on a method of ASTM C336.

It is said that a relaxation behavior of glass includes rapid relaxation and slow relaxation. The slow relaxation is a relaxation behavior mainly observed in the vicinity of the annealing point, and the thermal shrinkage is large, but a large amount of energy (for example, a high temperature) is required to cause a structural relaxation. On the other hand, the rapid relaxation is characterized in that the thermal shrinkage is very small, but the energy required to cause the structural relaxation is small.

The thermal shrinkage in a TFT array manufacturing step, which is a problem in glass for display, is mainly due to the rapid relaxation caused by a heat treatment step having a temperature considerably lower than the annealing point. Such rapid relaxation is considered to be caused by local structural distortion, an energetically unstable bond (for example, —OH group in glass), or the like. This is the reason why the thermal shrinkage is likely to occur when the cooling profile includes a rapidly cooled portion, and it is necessary to perform cooling so that the cooling profile does not include the rapidly cooled portion.

Therefore, the coefficient of determination R² in linear regression by the least-squares method is introduced as an index for cooling in a profile having a constant cooling rate as much as possible within a cooling time determined by a process without including a rapidly cooled portion. The higher the value is, the higher the linearity of the cooling profile in the range of linear regression is, that is, this indicates that the cooling rate of the cooling profile is constant.

In the method for manufacturing a glass substrate of the present invention, it is preferable that the cooling time in the temperature range from the annealing point of the glass substrate to 600° C. is 15 seconds or more. The temperature of the glass substrate at the time of manufacturing is preferably measured using a radiation thermometer or the like.

In the method for manufacturing a glass substrate of the present invention, it is preferable to form the molten glass by the overflow downdraw method.

In the method for manufacturing a glass substrate of the present invention, a β-OH value of the glass substrate is preferably 0.18/mm or less. Here, the “β-OH value” refers to a value obtained by measuring transmittance of glass using FT-IR and using the following formula.

β-OH value=(1/X)log₁₀ (T₁/T₂)

X: glass thickness (mm)

T₁: transmittance (%) at a reference wavelength of 3846 cm⁻¹

T₂: minimum transmittance (%) at vicinity of hydroxyl group absorption wavelength of 3600 cm⁻¹

In the method for manufacturing a glass substrate of the present invention, the glass substrate when subjected to a heat treatment at 500° C. for 1 hour preferably has a thermal shrinkage of 20 ppm or less. Here, the “thermal shrinkage when a heat treatment is performed at 500° C. for 1 hour” (hereinafter, also referred to as “thermal shrinkage at 500° C. for 1 hour”) is measured by the following method. First, as shown in FIG. 1(a), a strip-shaped sample G of 160 mm×30 mm is prepared as a measurement sample. A marking M is formed at a position 20 mm to 40 mm away from an end edge of each of both end portions of the strip-shaped sample G in a long side direction by using #1000 water-resistant abrasive paper. Thereafter, as shown in FIG. 1(b), the strip-shaped sample G on which the marking M is formed is folded and divided into two along a direction orthogonal to the marking M to manufacture sample pieces Ga and Gb. Then, only one sample piece Gb is heated from room temperature to 500° C. at a temperature increase rate of 5° C./min, held at 500° C. for 1 hour, and then subjected to a heat treatment in which the temperature is decreased at a temperature decrease rate of 5° C./min. After the heat treatment, as shown in FIG. 1(c), in a state where the sample piece Ga not subjected to the heat treatment and the sample piece Gb subjected to the heat treatment are arranged in parallel, positional deviation amounts (ΔL₁ and ΔL₂) of the markings M of the two sample pieces Ga and Gb are read by a laser microscope, and the thermal shrinkage is calculated by the following formula. Note that 10 mm in the following formula is a distance between the initial markings M.

Thermal shrinkage (ppm)=[{ΔL₁ (μm)+ΔL₂ (μm)}×10³]/10 (mm)

A method of measuring a “thermal shrinkage when a heat treatment is performed at 600° C. for 1 hour” (hereinafter, also referred to as “thermal shrinkage at 600° C. for 1 hour”) is the same as that described above except that the temperature is changed to 600° C. instead of 500° C.

In the method for manufacturing a glass substrate of the present invention, the glass substrate preferably has a thickness of 0.01 mm to 1 mm.

In the glass substrate of the present invention, a thermal shrinkage S when a heat treatment is performed at 500° C. for 1 hour and a cooling time t in seconds in a temperature range from an annealing point Ta of the glass substrate to 500° C. are represented by a relational expression of S=α₅₀₀ lnt+β₅₀₀, and a value of (β₅₀₀+476.93)/Ta is 0.5574 or more.

The glass substrate of the present invention preferably contains, in terms of mass %, 57% to 64% of SiO₂, 15% to 22% of Al₂O₃, 0% to 8% of B₂O₃, 0% to 8% of MgO, 2% to 10% of CaO, 0% to 5% of SrO, and 1% to 12% of BaO.

### Advantageous Effects of Invention

According to the present invention, it is possible to provide a cooling profile that is effective when manufacturing a glass substrate.

### BRIEF DESCRIPTION OF DRAWINGS

FIG. 1 is an illustrative diagram for illustrating a method of measuring a thermal shrinkage.

FIG. 2 is a diagram showing a relationship among a cooling time up to 500° C., a coefficient β₅₀₀ of an approximation formula of a thermal shrinkage at 500° C. for 1 hour, and an annealing point.

FIG. 3 is a diagram showing cooling profiles of Samples 1 to 5.

FIG. 4 is a diagram showing a cooling profile of Sample 6.

FIG. 5 is a diagram showing a cooling profile of Sample 7.

FIG. 6 is a diagram showing a cooling profile of Sample 8.

FIG. 7 is a diagram showing a cooling profile of Sample 9.

FIG. 8 is a diagram showing a cooling profile of Sample 10.

FIG. 9 is a diagram showing a cooling profile of Sample 11.

FIG. 10 is a diagram showing a cooling profile of Sample 12.

FIG. 11 is a diagram showing a cooling profile of Sample 13.

FIG. 12 is a diagram showing a cooling profile of Sample 14.

FIG. 13 is a diagram showing a cooling profile of Sample 15.

FIG. 14 is a diagram showing a cooling profile of Sample 16.

FIG. 15 is a diagram showing a cooling profile of Sample 17.

FIG. 16 is a diagram showing a cooling profile of Sample 18.

FIG. 17 is a diagram showing a cooling profile of Sample 19.

FIG. 18 is a diagram showing a cooling profile of Sample 20.

FIG. 19 is a diagram showing a cooling profile of Sample 21.

FIG. 20 is a diagram showing a cooling profile of Sample 22.

FIG. 21 is a diagram showing a cooling profile of Sample 23.

FIG. 22 is a diagram showing a cooling profile of Sample 24.

FIG. 23 is a diagram showing a cooling profile of Sample 25.

FIG. 24 is a diagram showing a cooling profile of Sample 26.

FIG. 25 is a diagram showing a relationship between a cooling time from an annealing point of glass A to 500° C. and a thermal shrinkage at 500° C. for 1 hour.

FIG. 26 is a diagram showing a relationship between a cooling time from the annealing point of the glass A to 600° C. and a thermal shrinkage at 600° C. for 1 hour.

FIG. 27 is a diagram showing a relationship between a cooling time from an annealing point of glass B to 500° C. and a thermal shrinkage at 500° C. for 1 hour.

FIG. 28 is a diagram showing a relationship between a cooling time from the annealing point of the glass B to 600° C. and a thermal shrinkage at 600° C. for 1 hour.

FIG. 29 is a diagram showing an approximate expression of the cooling time from the annealing point of the glass A to 500° C. and the thermal shrinkage at 500° C. for 1 hour.

FIG. 30 is a diagram showing an approximate expression of the cooling time from the annealing point of the glass B to 500° C. and the thermal shrinkage at 500° C. for 1 hour.

FIG. 31 is a diagram showing an approximate expression of a cooling time from an annealing point of glass C to 500° C. and a thermal shrinkage at 500° C. for 1 hour.

FIG. 32 is a diagram showing an approximate expression of a cooling time from an annealing point of glass D to 500° C. and a thermal shrinkage at 500° C. for 1 hour.

FIG. 33 is a diagram showing an approximate expression of a cooling time from an annealing point of glass E to 500° C. and a thermal shrinkage at 500° C. for 1 hour.

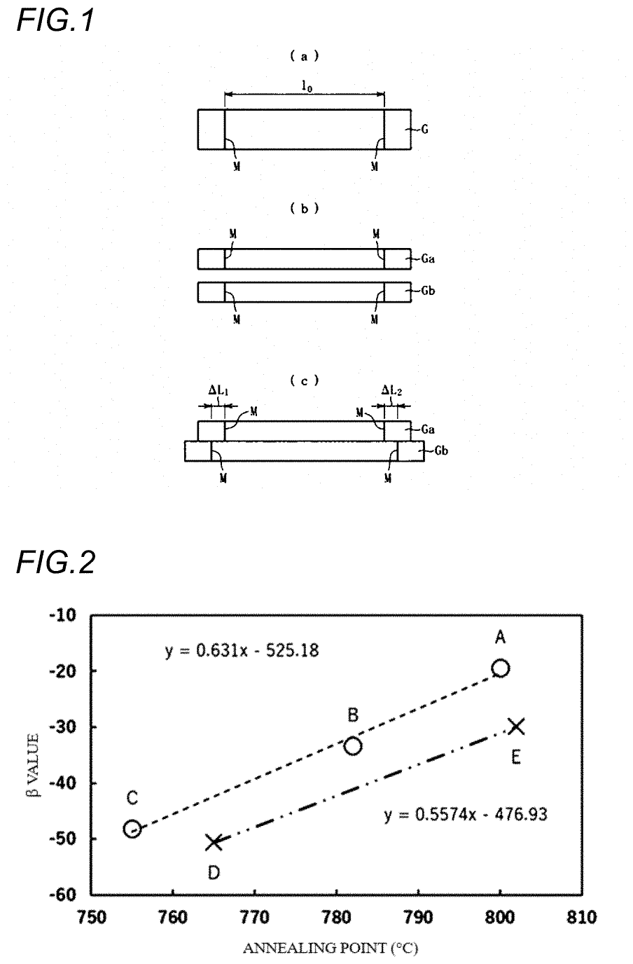

### DESCRIPTION OF EMBODIMENTS

A method for manufacturing a glass substrate of the present invention is a method for manufacturing a glass substrate having a strain point of 680° C. or higher. The method includes: a step of melting a glass raw material; and a step of forming molten glass. The forming step includes a step of cooling the molten glass such that a cooling time in a temperature range from an annealing point of the glass substrate to 500° C. is 35 seconds or more, and in a case where a cooling profile indicating a temperature change with respect to the cooling time is linearly approximated by a least-squares method in the temperature range from the annealing point of the glass substrate to 500° C., a coefficient of determination R² in the least-squares method is 0.7 or more. The reason why the cooling profile is controlled as described above will be described below.

First, it has been recognized as a well-known fact that, in order to reduce a thermal shrinkage of glass, it is preferable that the longer the time for performing the cooling treatment is, the more preferable it is. The term “cooling treatment” as used herein basically refers to a cooling action in a temperature range of about ±100° C. in the vicinity of the annealing point, and it has not been considered that the cooling profile up to 500° C. described as the present invention affects the reduction of the thermal shrinkage.

It has been empirically known that extending the cooling time is effective in reducing the thermal shrinkage, and the cooling time is recognized as a cooling time in the vicinity of the annealing point as described above. It has not been considered that the cooling profile in a low temperature region equal to or lower than the annealing point affects the reduction of the thermal shrinkage.

However, as a result of various studies, the present inventors have found that even in a temperature region lower than the annealing point, the cooling profile is considerably effective in reducing the thermal shrinkage.

In the method for manufacturing a glass substrate of the present invention, the cooling time in the temperature range from the annealing point of the glass substrate to 500° C. is 35 seconds or more, preferably 40 seconds or more, 50 seconds or more, 55 seconds or more, 60 seconds or more, 65 seconds or more, 70 seconds or more, and particularly preferably 75 seconds or more. When the cooling time is too short, the thermal shrinkage of the glass substrate tends to increase. On the other hand, when the cooling time is too long, the productivity is impaired, and thus the cooling time is preferably 500 seconds or less, and particularly preferably 300 seconds or less.

In the method for manufacturing a glass substrate of the present invention, the cooling time in the temperature range from the annealing point of the glass substrate to 550° C. is preferably 20 seconds or more, 25 seconds or more, 30 seconds or more, 35 seconds or more, 40 seconds or more, 50 seconds or more, 55 seconds or more, 60 seconds or more, 65 seconds or more, and particularly preferably 70 seconds or more. When the cooling time is too short, the thermal shrinkage of the glass substrate tends to increase. On the other hand, when the cooling time is too long, productivity is impaired, and therefore, the cooling time is preferably 500 seconds or less, 300 seconds or less, 250 seconds or less, 200 seconds or less, and particularly preferably 150 seconds or less.

In the method for manufacturing a glass substrate of the present invention, the cooling time in the temperature range from the annealing point of the glass substrate to 600° C. is preferably 15 seconds or more, 20 seconds or more, 25 seconds or more, 30 seconds or more, 35 seconds or more, 40 seconds or more, 50 seconds or more, 55 seconds or more, 60 seconds or more, and particularly preferably 65 seconds or more. When the cooling time is too short, the thermal shrinkage of the glass substrate tends to increase. On the other hand, when the cooling time is too long, productivity is impaired, and therefore, the cooling time is preferably 500 seconds or less, 300 seconds or less, 250 seconds or less, 200 seconds or less, and particularly preferably 150 seconds or less.

In the method for manufacturing a glass substrate of the present invention, the coefficient of determination R² when linearly approximated using the least-squares method in the temperature range from the annealing point to 500° C. in the cooling profile is 0.7 or more, preferably 0.75 or more, 0.8 or more, 0.85 or more, 0.9 or more, and particularly preferably 0.95 or more. When R² is too small, the cooling profile includes a rapidly cooled portion, and the thermal shrinkage of the glass substrate tends to increase.

Next, the method for manufacturing a glass substrate of the present invention will be described.

The manufacturing step of the glass substrate generally includes a melting step, a fining step, a supply step, a stirring step, and a forming step. The melting step is a step of melting a glass batch in which glass raw materials are mixed to obtain molten glass. The fining step is a step of fining the molten glass obtained in the melting step in accordance with an action of a fining agent or the like. The supply step is a step of transferring the molten glass between the respective steps. The stirring step is a step of stirring and homogenizing the molten glass. The forming step is a step of forming the molten glass into flat plate-shaped glass. The forming step includes the cooling step described above. If necessary, a step other than the above, for example, a state adjusting step of adjusting the molten glass to a state suitable for forming may be incorporated after the stirring step.

When conventional low-alkali glass is industrially manufactured, a glass raw material is generally melted by heating with a burning flame of a burner. The burner is usually disposed above a melting kiln, and fossil fuel, specifically, liquid fuel such as heavy oil, gaseous fuel such as LPG, or the like is used as fuel. The burning flame can be obtained by mixing fossil fuel and oxygen gas. However, in this method, since a large amount of moisture is mixed into the molten glass at the time of melting, a β-OH value is likely to increase. Therefore, in the manufacturing of the glass of the present invention, it is preferable to perform energization heating by a heating electrode, and it is preferable to melt the glass raw material by the energization heating by the heating electrode without performing the heating by the burning flame of the burner. This makes it difficult for moisture to be mixed into the molten glass at the time of melting, so that the β-OH value is likely to decrease. Furthermore, when the energization heating is performed by the heating electrode, an amount of energy per mass for obtaining the molten glass is decreased, and an amount of molten volatiles is decreased, so that the environmental load can be reduced.

The energization heating by the heating electrode is preferably performed by applying an alternating current voltage to the heating electrode provided at the bottom or the side of the melting kiln so as to be in contact with the molten glass in the melting kiln. A material used for the heating electrode is preferably a material having heat resistance and corrosion resistance to the molten glass, and examples thereof include tin oxide, molybdenum, platinum, and rhodium, and molybdenum is particularly preferable.

Since the glass substrate of the present invention is low alkali glass that does not contain a large amount of alkali metal oxide, the glass substrate has a high electrical resistivity. Therefore, when the energization heating by the heating electrode is applied to the low alkali glass, a current flows not only to the molten glass but also to a refractory constituting the melting kiln, which may damage the refractory constituting the melting kiln at an early stage. In order to prevent this, it is preferable to use a zirconia-based refractory having a high electrical resistivity, particularly a zirconia electrocast brick, as the furnace refractory, and a content of ZrO₂ in the zirconia-based refractory is preferably 85 mass % or more, and particularly preferably 90 mass % or more.

Next, the characteristics and composition of the glass substrate used in the present invention will be described. In the present specification, a numerical range indicated by using “to” means a range including numerical values before and after “to” as a minimum value and a maximum value, respectively.

The thermal shrinkage when the heat treatment is performed at 500° C. for 1 hour is preferably 30 ppm or less, 25 ppm or less, and particularly preferably 20 ppm or less. In this case, a defect such as a pattern shift is less likely to occur.

A strain point is 680° C. or higher, preferably 700° C. or higher, 705° C. or higher, 710° C. or higher, 715° C. or higher, 720° C. or higher, 725° C. or higher, and particularly preferably 730° C. or higher. When the strain point is low, the glass substrate is likely to be thermally shrunk in the manufacturing step. An upper limit of the strain point is not particularly limited, but is preferably 850° C. or less, 840° C. or less, 830° C. or less, 820° C. or less, 810° C. or less, and particularly preferably 800° C. or less in consideration of the burden on the manufacturing equipment. Here, the “strain point” refers to a value measured based on a method of ASTM C336.

An average thermal expansion coefficient in the temperature range of 30° C. to 380° C. is preferably 45×10⁻⁷/° C. or less, 34×10⁻⁷ to 43×10⁻⁷/° C., and particularly preferably 36×10⁻⁷ to 40×10⁻⁷/° C. When the average thermal expansion coefficient in the temperature range of 30° C. to 380° C. is out of the above range, the average thermal expansion coefficient does not match a thermal expansion coefficient of a peripheral member, and peeling of the peripheral member or warpage of the glass substrate is likely to occur. In addition, when the value is large, a pitch deviation due to temperature unevenness at the time of heat treatment is likely to occur. Here, the “thermal expansion coefficient” refers to the average thermal expansion coefficient measured in the temperature range of 30° C. to 380° C., and can be measured by, for example, a dilatometer.

The higher the Young's modulus is, the more difficult the glass substrate is to be deformed. In recent years, since a glass substrate such as an organic EL substrate has increased definition, it is necessary to increase a thickness of a metal wiring in order to prevent sheet resistance. As a result, a glass substrate is strongly required to have higher rigidity than a conventional product. Therefore, the Young's modulus is preferably 78 GPa or more, 79 GPa or more, and particularly preferably 80 GPa or more. Here, the “Young's modulus” refers to a value measured based on a dynamic elastic modulus measurement method (resonance method) based on JIS R1602.

The specific Young's modulus is preferably more than 29.5 GPa/g·cm⁻³, 30 GPa/g·cm⁻³ or more, 30.5 GPa/g·cm⁻³ or more, 31 GPa/g·cm⁻³ or more, 31.5 GPa/g·cm⁻³ or more, and particularly preferably 32 GPa/g·cm⁻³ or more. When the specific Young's modulus is high, the glass substrate is easily bent by the own weight thereof.

A liquidus temperature is preferably less than 1300° C., 1280° C. or less, 1250° C. or less, 1230° C. or less, and particularly preferably 1220° C. or less. When the liquidus temperature is high, devitrified crystals are generated at the time of forming by the overflow downdraw method or the like, and the productivity of the glass substrate is likely to lower. Here, the “liquidus temperature” refers to a temperature at which a glass powder, which has passed through a standard sieve of 30 mesh (with a mesh opening of 500 μm) and remains at a standard sieve of 50 mesh (with a mesh opening of 300 μm), is placed in a platinum boat, and kept in a temperature gradient furnace set at 1100° C. to 1350° C. for 24 hours, then the platinum boat is taken out, and devitrified crystals (crystal foreign substances) are observed in the glass.

A liquidus viscosity is preferably 10^{4.2} dPa·s or more, 10^{4.4} dPa·s or more, 10^{4.6} dPa·s or more, 10^{4.8} dPa·s or more, and particularly preferably 10^{5.0} dPa·s or more. When the liquidus viscosity is low, devitrified crystals are generated at the time of forming by the overflow downdraw method or the like, and the productivity of the glass substrate is likely to lower. Here, the term “liquidus viscosity” refers to a value obtained by measuring the viscosity of glass at the liquidus temperature by a platinum sphere pull up method.

A temperature at a viscosity in high temperature of 10^{2.5} dPa·s is preferably 1660° C. or less, 1640° C. or less, 1620° C. or less, 1600° C. or less, and particularly preferably 1590° C. or less. When the temperature at a viscosity in high temperature of 10^{2.5} dPa·s is high, it is difficult to dissolve the glass, and the manufacturing cost of the glass substrate is increased.

In the glass substrate of the present invention, when the β-OH value is decreased, the strain point can be increased, and the thermal shrinkage can be significantly reduced. The β-OH value is preferably 0.30/mm or less, 0.25/mm or less, 0.20/mm or less, 0.18/mm or less, and particularly preferably 0.15/mm or less. When the β-OH value is too large, the strain point is decreased, and the thermal shrinkage is likely to increase. When the β-OH value is too small, the meltability is likely to decrease. Therefore, the β-OH value is preferably 0.01/mm or more, and particularly preferably 0.02/mm or more.

Examples of the method for decreasing the β-OH value include the following methods. (1) A raw material having a low water content is selected. (2) A component (Cl, SO₃, or the like) that reduces an amount of moisture in the glass is added. (3) An amount of water in the atmosphere in the furnace is decreased. (4) N₂ bubbling is performed in the molten glass. (5) A small melting furnace is employed. (6) A flow rate of molten glass is increased. (7) An electric melting method is employed.

It is preferable that the glass substrate has a flat plate shape and has an overflow merging surface at a central portion in a thickness direction. That is, it is preferable to form the glass substrate by the overflow downdraw method. The overflow downdraw method is a method in which molten glass is caused to overflow from both sides of a wedge-shaped refractory, and the overflowed molten glass is formed into a flat plate shape by being stretched and formed downward while joining the molten glass at a lower end of the wedge shape. In the overflow downdraw method, a surface to be a surface of the glass substrate is formed in a state of a free surface without being in contact with a refractory. Therefore, a glass substrate having excellent surface quality without polishing can be manufactured at low cost, and it is easy to increase an area and reduce the thickness.

The thickness of the glass substrate is not particularly limited, but is preferably 1.0 mm or less, 0.5 mm or less, 0.4 mm or less, 0.35 mm or less, and particularly preferably 0.3 mm or less in order to easily reduce the weight of the device. On the other hand, when the thickness is too small, the glass substrate is likely to bend. Therefore, the thickness of the glass substrate is preferably 0.001 mm or more, and particularly preferably 0.01 mm or more. The thickness can be adjusted by a flow rate, a sheet drawing speed, and the like at the time of manufacturing the glass.

A composition of the glass substrate is not particularly limited, but preferably contains 57% to 64% of SiO₂, 15% to 22% of Al₂O₃, 0% to 8% of B₂O₃, 0% to 8% of MgO, 2% to 10% of CaO, 0% to 5% of SrO, and 1% to 12% of BaO. The reason why the content of each component is limited as described above will be described below. In the description of the content of each component, “%” represents “mass %” unless otherwise specified.

SiO₂ is a component that forms a network of glass, is a component that increases a strain point, and is a component that further increases acid resistance. On the other hand, when the content of SiO₂ is high, the viscosity in high temperature is increased, the meltability is decreased, devitrified crystals such as cristobalite are likely to be precipitated, and the liquidus temperature is increased. Therefore, the content of SiO₂ is preferably 57% to 64%, 58% to 63%, and particularly preferably 59% to 62%.

Al₂O₃ is a component that forms a network of glass, a component that increases a strain point, and a component that further increases Young's modulus. On the other hand, when the content of Al₂O₃ is high, mullite or feldspar-based devitrified crystals are likely to be precipitated, and the liquidus temperature is increased. Therefore, the content of Al₂O₃ is preferably 15% to 22%, 17% to 21%, and particularly preferably 18% to 20%.

B₂O₃ is a component that enhances meltability and devitrification resistance. On the other hand, when the content of B₂O₃ is high, the strain point and the Young's modulus are reduced, and thus an increase in the thermal shrinkage and a pitch deviation in the panel manufacturing step are likely to occur. Therefore, an upper limit content of B₂O₃ is preferably 8% or less, 7% or less, 6% or less, 5% or less, and particularly preferably 4% or less, and a lower limit content is preferably 0% or more, 0.5% or more, 1% or more, 1.5% or more, 1.7% or more, 2% or more, 2.5% or more, and particularly preferably 3% or more.

MgO is a component that decreases the viscosity at high temperature, increases the meltability, and increases the Young's modulus. On the other hand, when the content of MgO is high, precipitation of crystals derived from mullite, Mg, and Ba and crystals of cristobalite is promoted. In addition, when the content of MgO is high, the strain point is significantly decreased. Therefore, the content of MgO is preferably 0% to 8%, 1% to 7%, and particularly preferably 2% to 6%.

CaO is a component that lowers the viscosity in high temperature without lowering the strain point and significantly enhances the meltability. In addition, among alkaline earth metal oxides, CaO is a component that reduces the raw material cost because the raw material to be introduced is relatively inexpensive. Further, CaO is a component that increases the Young's modulus. CaO has an effect of preventing the precipitation of the devitrified crystals containing Mg. On the other hand, when the content of CaO is high, devitrified crystals of anorthite are likely to be precipitated, and the density is likely to be increased. Therefore, the content of CaO is preferably 2% to 10%, 3% to 9%, and particularly preferably 4% to 8%.

SrO is a component that prevents phase separation and increases devitrification resistance. Further, SrO is a component that lowers the viscosity in high temperature without lowering the strain point, and enhances the meltability. On the other hand, when the content of SrO is high, feldspar-based devitrification crystal is likely to be precipitated in the glass system containing a large amount of CaO, and the devitrification resistance is likely to be decreased. Further, when the content of SrO is high, the density tends to increase and the Young's modulus tends to decrease. Therefore, the content of SrO is preferably 0% to 5%, 0% to 4%, and particularly preferably 0.1% to 3%.

BaO is a component having a high effect of preventing precipitation of a mullite-based or anorthite-based devitrified crystal among alkaline earth metal oxides. On the other hand, when the content of BaO is high, the density is likely to increase and the Young's modulus is likely to decrease, and the viscosity in high temperature is too high and the meltability is likely to decrease. Therefore, the content of BaO is preferably 1% to 12%, 2% to 11%, and particularly preferably 3% to 10%.

From the viewpoint of reducing the thermal shrinkage of the glass, it is preferable that the glass does not substantially contain an alkali metal oxide. Specifically, the content of the alkali metal oxide is preferably 0.1% or less, 0.05% or less, 0.04% or less, 0.03% or less, and particularly preferably 0.02% or less, in terms of mass %.

Next, a relationship between the thermal shrinkage of the glass substrate and the cooling time will be described in detail.

A thermal shrinkage Sx (ppm) at x° C. of a glass substrate that has passed the cooling profile of the present invention can be expressed by the following formula using a cooling time t (second) in a temperature range of Ta to x° C.

Sx=αₓ·lnt+βₓ

The calculation methods of α₅₀₀ and β₅₀₀ are described below.

First, a graph is created in which a cooling time from an annealing point to 500° C. is plotted on a horizontal axis and a thermal shrinkage at 500° C. for 1 hour is plotted on a vertical axis. Next, α₅₀₀ and β₅₀₀ can be obtained by fitting the created graph.

With respect to glasses A to E having annealing points described in Table 1, FIG. 2 show a plot of the annealing points on a horizontal axis, and the values of β₅₀₀ calculated by the above method on a vertical axis.

TABLE 1

| | A | B | C | D | E |
|---|---|---|---|---|---|
| Annealing point Ta | 800° C. | 782° C. | 755° C. | 765° C. | 802° C. |

It is known that an absolute value of the thermal shrinkage is also affected by the viscosity characteristics of the glass, that is, the annealing point. Specifically, as the annealing point is higher, the thermal shrinkage tends to be smaller, and this tendency can also be seen from FIG. 2.

On the other hand, it can be seen that there is a variation in the plot depending on the glass in a vertical direction of an approximate straight line. This suggests that there is a thermal shrinkage characteristic that cannot be described by the viscosity characteristic. Since glass having a high annealing point generally has a high production load, glass having a plot on an upper left of the plot shown in FIG. 2 is preferable in order to manufacture glass having a low thermal shrinkage at low cost.

Specifically, since the glass of D and E (x mark) in FIG. 2 is insufficient in productivity as a substrate having a low thermal shrinkage, glass having a characteristic that can being plotted at least on the upper left of an approximate straight line connecting D and E is preferable. Therefore, the condition is (β₅₀₀+476.93)/Ta≥0.5574. Preferably, ((β₅₀₀+476.93)/Ta is 0.558 or more, 0.559 or more, 0.56 or more, 0.561 or more, and particularly 0.562 or more. By designing the glass substrate like this, it is possible to provide a glass substrate that can achieve a low thermal shrinkage at low cost.

### EXAMPLE

Hereinafter, the present invention will be described based on Examples, but the present invention is not limited to the following Examples. Table 3 shows examples (samples 5 to 26) and comparative examples (samples 1 to 4) of the present invention.

Table 2 shows compositions and annealing points Ta of the glasses A to E used in the experiment.

TABLE 2

| Mass % | A | B | C | D | E |
|---|---|---|---|---|---|
| SiO, | 61 | 61 | 59 | 63 | 62 |
| AI2O3 | 19 | 20 | 18 | 18 | 16 |
| B2O3 | 1 | 3 | 7 | 6 | 0 |
| MgO | 3 | 4 | 3 | 1 | 0 |
| CaO | 4 | 5 | 6 | 7 | 9 |
| SrO | 3 | 3 | 1 | 3 | 2 |
| BaO | 9 | 4 | 6 | 2 | 11 |
| Annealing point | 800° C. | 782° C. | 755° C. | 765° C. | 802° C. |
| Ta | | | | | |

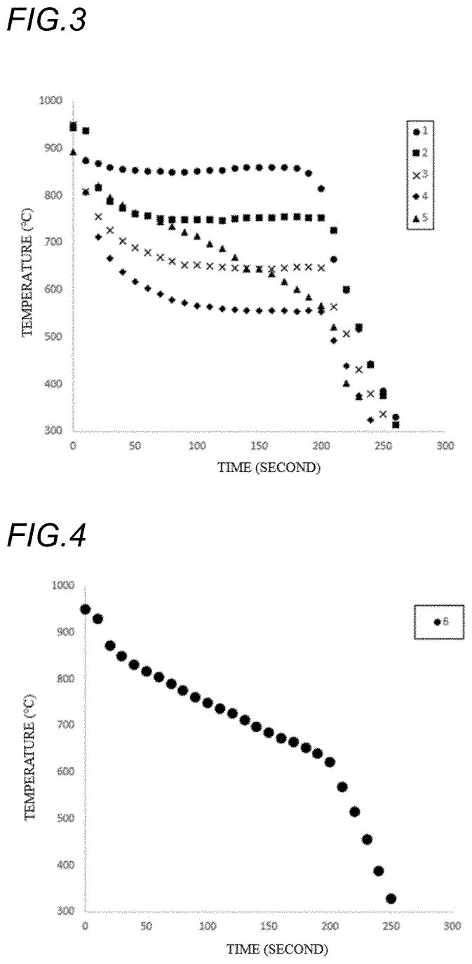

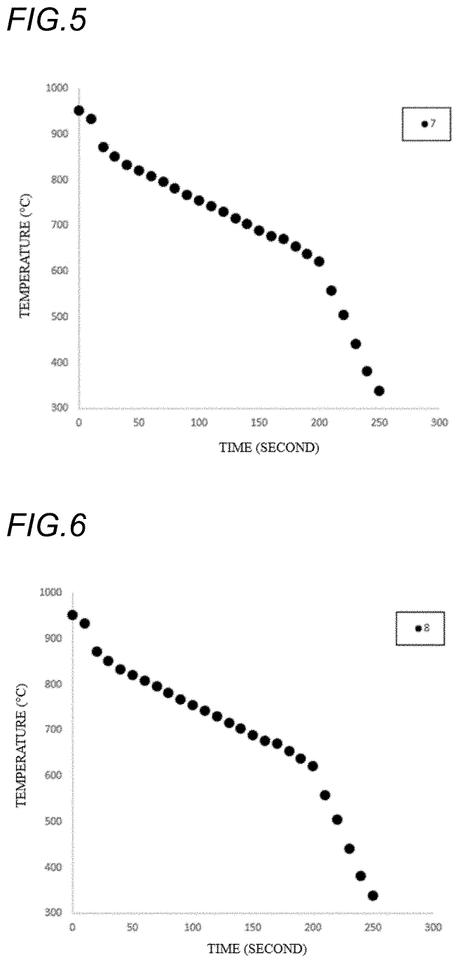

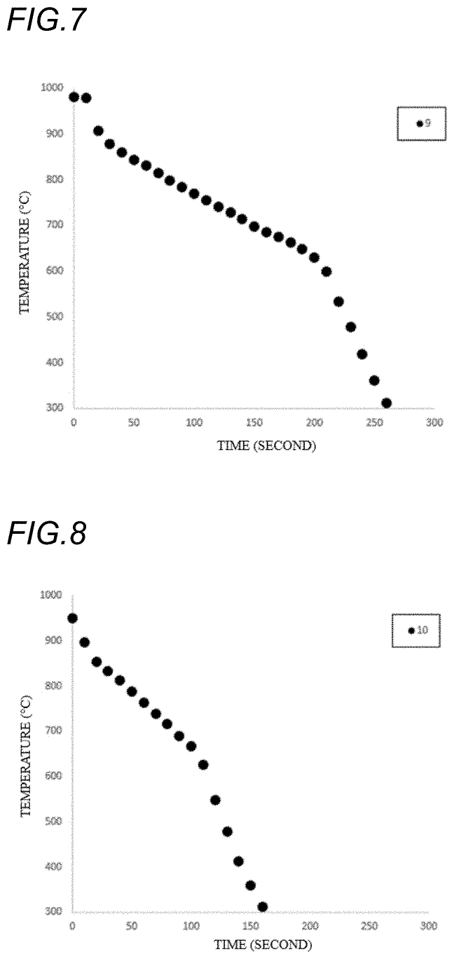

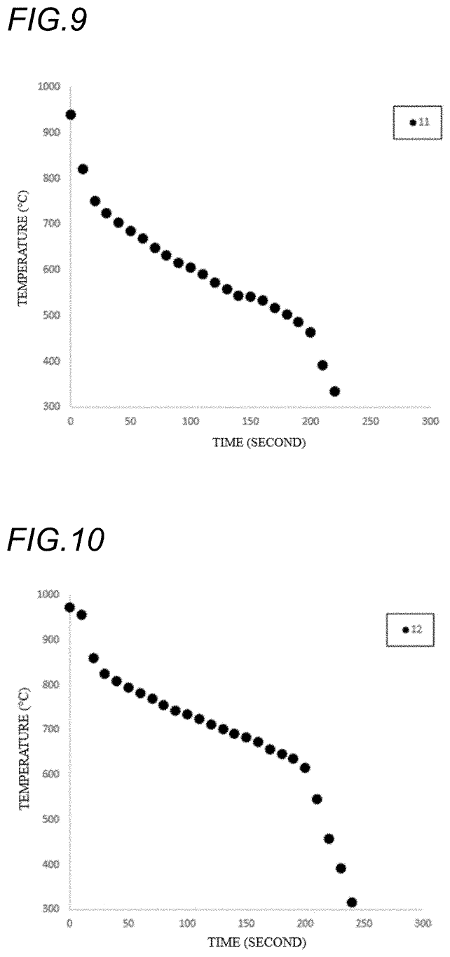

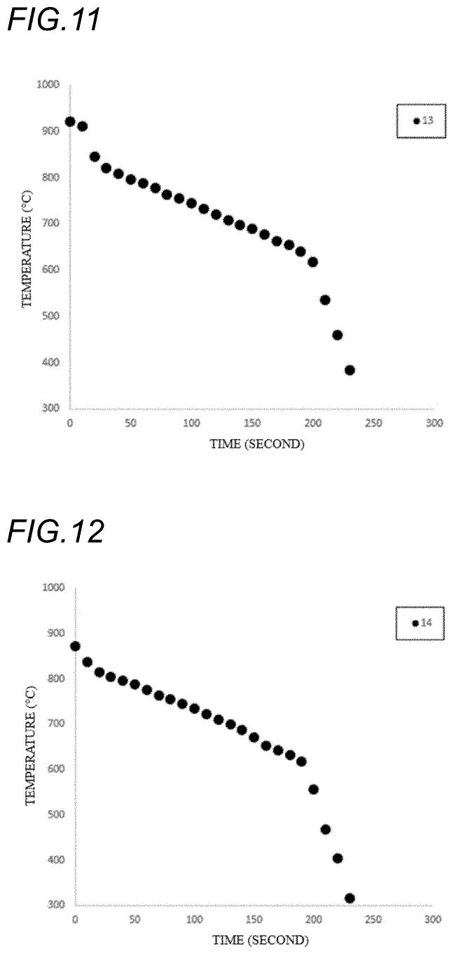

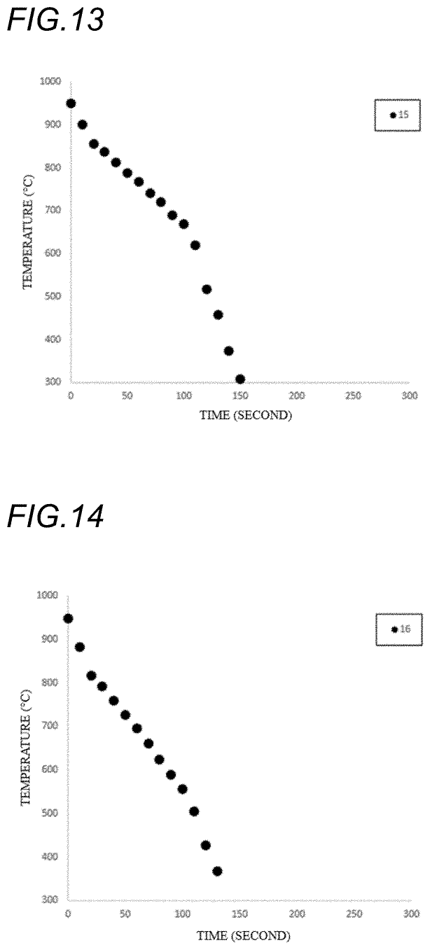

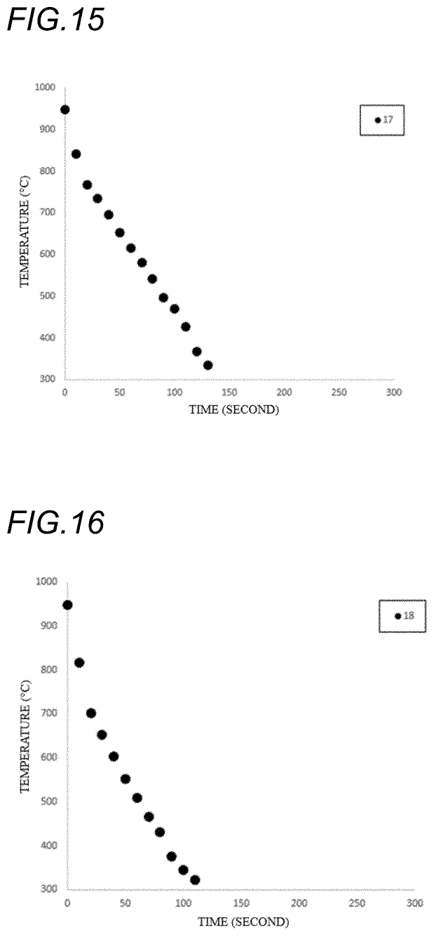

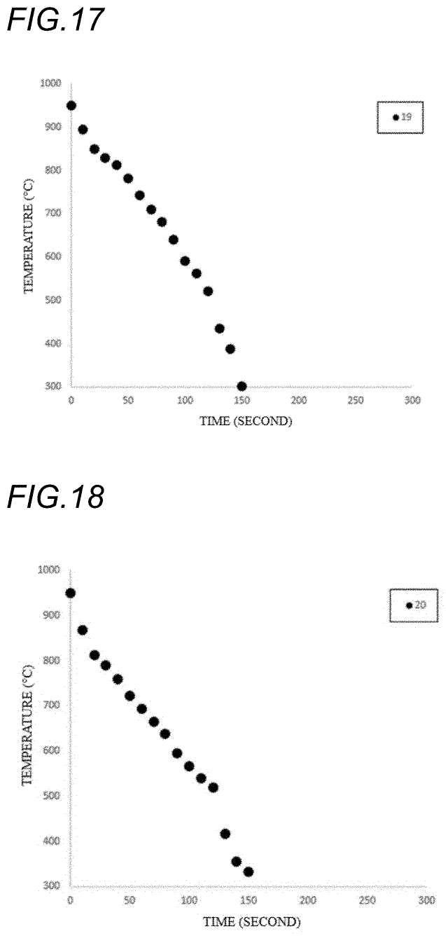

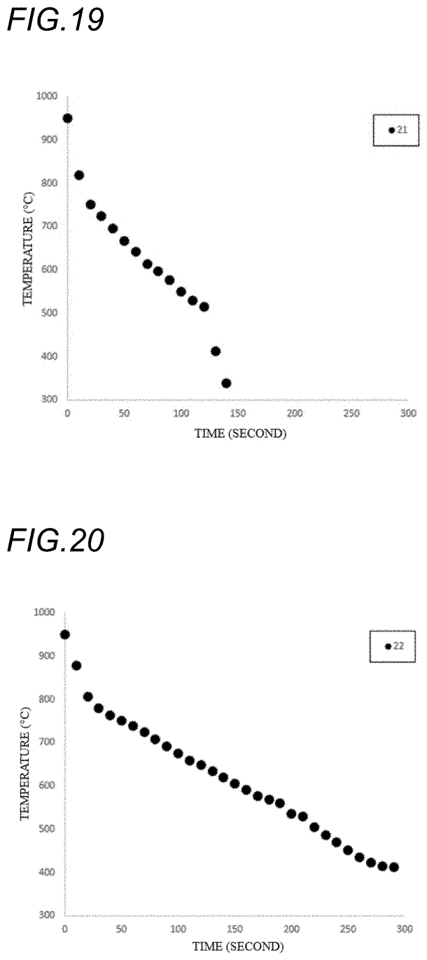

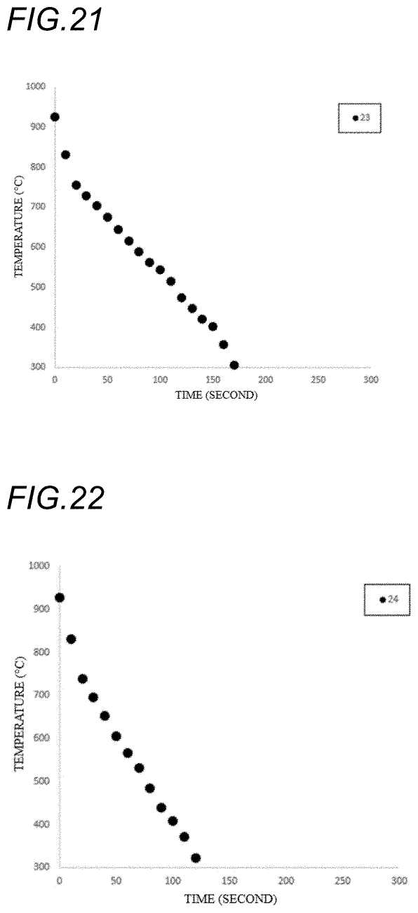

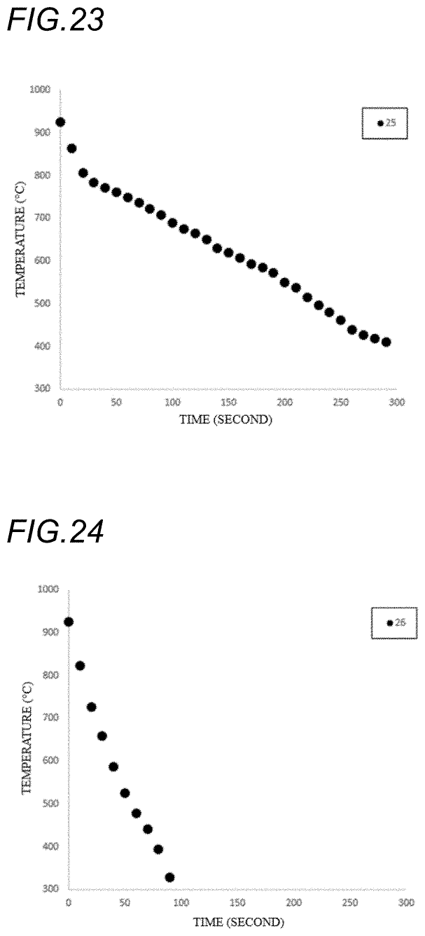

The glasses A and B were held at an annealing point of ±70° C. to 170° C. for 30 minutes, and cooled with various cooling profiles after a thermal history was sufficiently canceled. FIGS. 3 to 24 show cooling profiles of samples 1 to 26. For comparison, the temperature holding step described above is omitted, and a time at which cooling starts is set to 0 second. The glass A was used in Samples 1 to 22, and the glass B was used in Samples 23 to 26. A temperature at this time is measured by attaching a thermocouple to a center of the glass sample. Since the above experiment includes a step of canceling the thermal history, any sample having any thermal history can be used.

Table 3 shows a cooling time from the annealing point to 500° C., a cooling time from the annealing point to 600° C., a coefficient of determination R² when linearly approximated by a least-squares method in each temperature range in the cooling profiles of Samples 1 to 22, and measurement results of the thermal shrinkage of the glass samples manufactured with the cooling profiles at 500° C. for 1 hour and 600° C. for 1 hour.

TABLE 3

| | | Coefficient of | | | Coefficient of | |
|---|---|---|---|---|---|---|
| | | determination | | | determination | |
| | Cooling time | R² linearly | Thermal | Cooling time | R² linearly | Thermal |
| | from Ta to | approximated | shrinkage | from Ta to | approximated | shrinkage |
| | 500° C. | between Ta and | (ppm) at 500° C. | 600° C. | between Ta and | (ppm) at 600° C. |
| Sample | (second) | 500° C. | for 1 hour | (second) | 600° C. | for 1 hour |
| 1 | 31 | 0.973 | −11.5 | 19 | 0.951 | −56.6 |
| 2 | 207 | 0.440 | −8.1 | 194 | 0.397 | −34.9 |
| 3 | 209 | 0.686 | −9.3 | 194 | 0.682 | −39.1 |
| 4 | 198 | 0.667 | −9.1 | 52 | 0.866 | −50.5 |
| 5 | 183 | 0.915 | −6.4 | 152 | 0.994 | |
| 6 | 160 | 0.907 | −7.2 | 141 | 0.975 | −31.3 |
| 7 | 154 | 0.896 | −8.3 | 137 | 0.986 | −30.5 |
| 8 | 154 | 0.896 | −7.4 | 137 | 0.966 | −31.6 |
| 9 | 147 | 0.926 | −7.5 | 131 | 0.995 | |
| 10 | 82 | 0.935 | −8.6 | 68 | 0.954 | −38.9 |
| 11 | 169 | 0.960 | −8.1 | 90 | 0.942 | −37.3 |
| 12 | 169 | 0.878 | −7.7 | 156 | 0.955 | −43.3 |
| 13 | 168 | 0.872 | −7.2 | 155 | 0.936 | −28.6 |
| 14 | 171 | 0.896 | −6.5 | 158 | 0.967 | −27.7 |
| 15 | 80 | 0.902 | −9.9 | 68 | 0.978 | −41.2 |
| 16 | 84 | 0.997 | −9.2 | 61 | 0.998 | −40.8 |
| 17 | 75 | 0.999 | −9.1 | 51 | 0.998 | −43.9 |
| 18 | 51 | 0.979 | −10.0 | 29 | 0.952 | −50.9 |
| 19 | 79 | 0.997 | −8.0 | 52 | 0.991 | −39.7 |
| 20 | 96 | 0.998 | −8.9 | 63 | 0.998 | −38.1 |
| 21 | 111 | 0.990 | −8.1 | 67 | 0.991 | −40.0 |
| 22 | 200 | 0.998 | −6.8 | 131 | 0.999 | −31.3 |

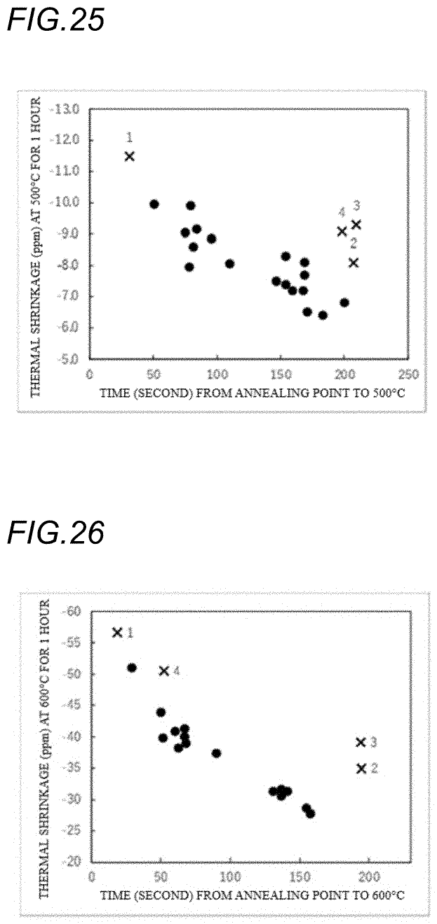

For Samples 1 to 22, FIG. 25 shows a plot of a cooling time from an annealing point to 500° C. shown in Table 2 on a horizontal axis, and a thermal shrinkage at 500° C. for 1 hour on a vertical axis, and FIG. 26 shows a plot of a cooling time from the annealing point to 600° C. on a horizontal axis and a thermal shrinkage at 600° C. for 1 hour on a vertical axis.

It can be seen from FIGS. 25 and 26 that the thermal shrinkage of the obtained glass is decreased as the cooling time from the annealing point to 500° C. or from the annealing point to 600° C. is increased. In particular, the thermal shrinkage of Sample 1 having a short cooling time is high. This is a result strongly suggesting that even cooling in a temperature range considerably lower than the vicinity of the annealing point has an influence on the thermal shrinkage.

On the other hand, in Samples 2 to 4, even when the cooling time from the annealing point to 500° C. or from the annealing point to 600° C. is increased, the effect of reducing the thermal shrinkage is very small. This is because a rapidly cooled portion is included in the temperature range from the annealing point to 500° C. or from the annealing point to 600° C. in the cooling profile. When the cooling profile includes the rapidly cooled portion, the glass structure is distorted during cooling, and the strain is considered to be a cause of an increase in the thermal shrinkage.

It can be seen that R² of Samples 2 to 4 in which the thermal shrinkage was increased although the cooling time was long was less than 0.7, the linearity of the cooling profile was appropriately expressed by this evaluation method, and the thermal shrinkage was increased when the linearity was decreased.

Table 4 shows the cooling time from the annealing point to 500° C., the cooling time from the annealing point to 600° C., and the coefficient of determination R² when linearly approximated by the least-squares method in each temperature range in the cooling profiles of Samples 23 to 26, and the measurement results of the thermal shrinkage of the glass samples produced by the cooling profiles at 500° C. for 1 hour and 600° C. for 1 hour.

TABLE 4

| | | Coefficient of | | | Coefficient of | |
|---|---|---|---|---|---|---|
| | | determination | | | determination | |
| | Cooling time | R² linearly | Thermal | Cooling time | R² linearly | Thermal |
| | from Ta to | approximated | shrinkage | from Ta to | approximated | shrinkage |
| | 500° C. | between Ta and | (ppm) at 500° C. | 600° C. | between Ta and | (ppm) at 600° C. |
| Sample | (second) | 500° C. | for 1 hour | (second) | 600° C. | for 1 hour |
| 23 | 100 | 0.996 | −11.9 | 63 | 0.993 | −65.6 |
| 24 | 63 | 0.994 | −13.8 | 39 | 0.990 | −78.6 |
| 25 | 199 | 0.998 | −8.9 | 144 | 0.998 | −54.6 |
| 26 | 42 | 0.997 | −16.1 | 26 | 0.995 | −97.7 |

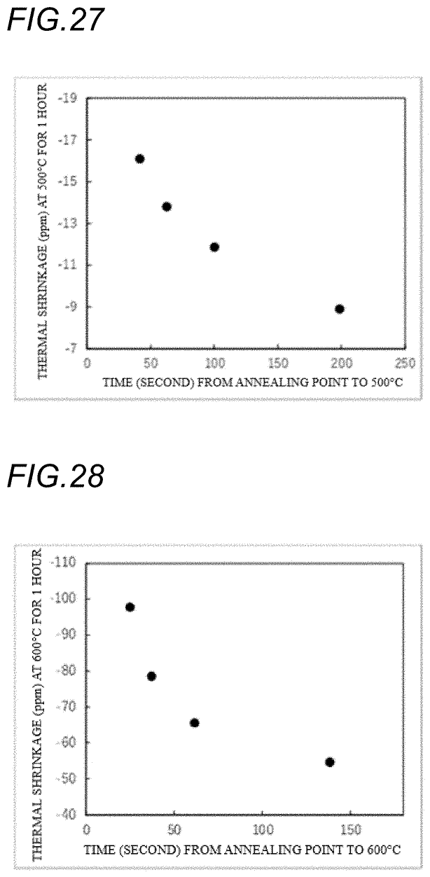

For Samples 23 to 26, FIG. 27 shows a plot of a cooling time from an annealing point to 500° C. shown in Table 3 on a horizontal axis and a thermal shrinkage at 500° C. for 1 hour on a vertical axis, and FIG. 28 shows a plot of a cooling time from the annealing point to 600° C. on a horizontal axis and a thermal shrinkage at 600° C. for 1 hour on a vertical axis.

As is clear from FIGS. 27 and 28, the same tendency as that of the glass A can be seen in the glass B. From this, it can be seen that the method for controlling a profile described as the present invention hardly depends on the composition of glass.

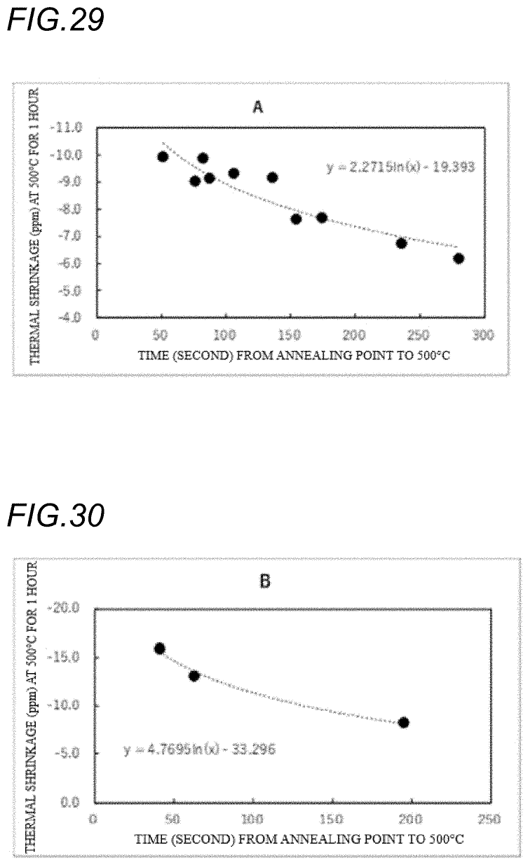

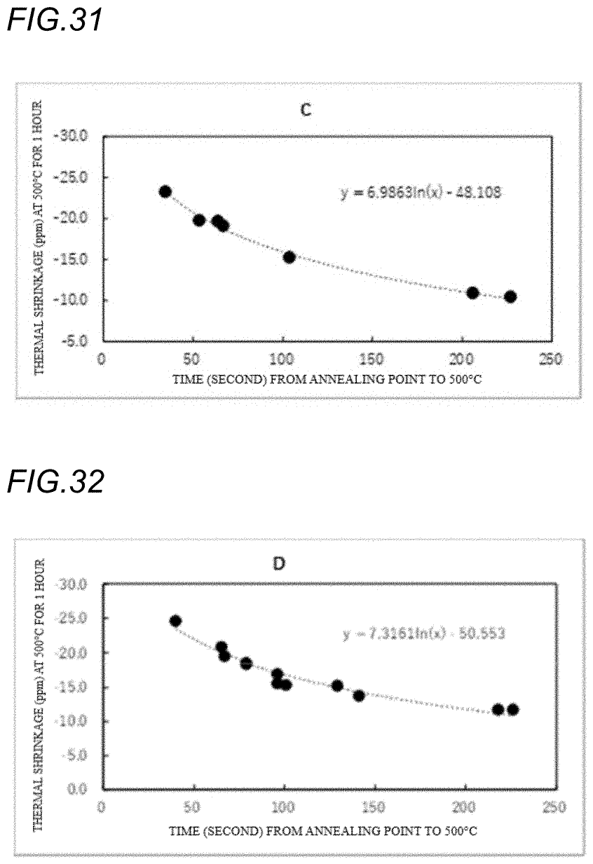

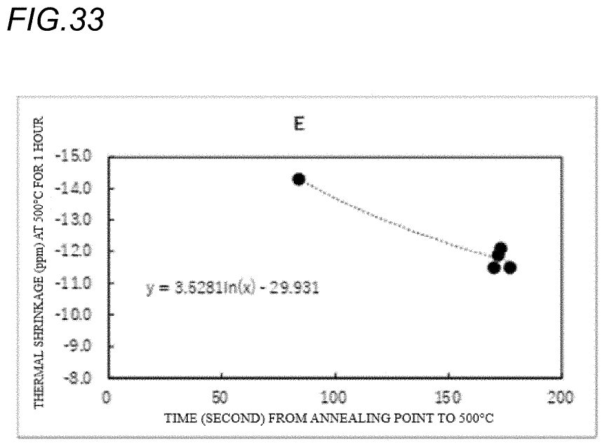

For the glasses A and B, FIGS. 29 and 30 show graphs obtained by fitting graphs in FIGS. 25 and 27 with a formula of S₅₀₀=α₅₀₀·lnt·β₅₀₀. Similarly, for the glasses C to E, FIGS. 31 to 33 show graphs obtained by creating and then fitting graphs of the cooling time from the annealing point to 500° C. and the thermal shrinkage at 500° C. for 1 hour. The results of obtaining α₅₀₀ and β₅₀₀ of the glasses A to E from FIGS. 29 to 33 are shown in Table 5.

TABLE 5

| | A | B | C | D | E |
|---|---|---|---|---|---|
| α₅₀₀ | 2.2715 | 4.7695 | 6.9863 | 7.3161 | 3.5281 |
| β₅₀₀ | −19.393 | −33.296 | −48.108 | −50.553 | −29.931 |
| Annealing point Ta (° C.) | 800 | 782 | 755 | 765 | 802 |
| (β₅₀₀ + 476.93)/Ta | 0.57193 | 0.56732 | 0.56799 | 0.55737 | 0.55737 |

FIG. 2 can be obtained by plotting the value of β₅₀₀ on the vertical axis with the annealing point shown in Table 5 on the horizontal axis.

1: A method for manufacturing a glass substrate having a strain point of 680° C. or higher, the method comprising:
melting a glass raw material; and
forming a molten glass,
wherein the forming comprises cooling the molten glass such that a cooling time in a temperature range from an annealing point of the glass substrate to 500° C. is 35 seconds or more, and in a case where a cooling profile indicating a temperature change with respect to the cooling time is linearly approximated by a least-squares method in the temperature range from the annealing point of the glass substrate to 500° C., a coefficient of determination R² in the least-squares method is 0.7 or more.

2: The method for manufacturing a glass substrate according to claim 1, wherein a cooling time in a temperature range from the annealing point of the glass substrate to 600° C. is 15 seconds or more.

3: The method for manufacturing a glass substrate according to claim 1, wherein the molten glass is formed by an overflow downdraw method.

4: The method for manufacturing a glass substrate according to claim 1, wherein the glass substrate has a β-OH value of 0.18/mm or less.

5: The method for manufacturing a glass substrate according to claim 1, wherein the glass substrate when subjected to a heat treatment at 500° C. for 1 hour has a thermal shrinkage of 20 ppm or less.

6: The method for manufacturing a glass substrate according to claim 1, wherein the glass substrate has a thickness of 0.01 mm to 1 mm.

7: A glass substrate, wherein a thermal shrinkage S of the glass substrate when subjected to a heat treatment at 500° C. for 1 hour and a cooling time tin seconds in a temperature range from an annealing point Ta of the glass substrate to 500° C. are expressed by a relational expression of S=α₅₀₀·lnt+β₅₀₀, and a value of (β₅₀₀+476.93)/Ta is 0.5574 or more.

8: The glass substrate according to claim 7, comprising: in terms of mass %, 57% to 64% of SiO₂, 15% to 22% of Al₂O₃, 0% to 8% of B₂O₃, 0% to 8% of MgO, 2% to 10% of CaO, 0% to 5% of SrO, and 1% to 12% of BaO.

9: The method for manufacturing a glass substrate according to claim 2, wherein the molten glass is formed by an overflow downdraw method.

10: The method for manufacturing a glass substrate according to claim 2, wherein the glass substrate has a β-OH value of 0.18/mm or less.

11: The method for manufacturing a glass substrate according to claim 3, wherein the glass substrate has a β-OH value of 0.18/mm or less.

12: The method for manufacturing a glass substrate according to claim 9, wherein the glass substrate has a β-OH value of 0.18/mm or less.

13: The method for manufacturing a glass substrate according to claim 2, wherein the glass substrate when subjected to a heat treatment at 500° C. for 1 hour has a thermal shrinkage of 20 ppm or less.

14: The method for manufacturing a glass substrate according to claim 3, wherein the glass substrate when subjected to a heat treatment at 500° C. for 1 hour has a thermal shrinkage of 20 ppm or less.

15: The method for manufacturing a glass substrate according to claim 9, wherein the glass substrate when subjected to a heat treatment at 500° C. for 1 hour has a thermal shrinkage of 20 ppm or less.

16: The method for manufacturing a glass substrate according to claim 4, wherein the glass substrate when subjected to a heat treatment at 500° C. for 1 hour has a thermal shrinkage of 20 ppm or less.

17: The method for manufacturing a glass substrate according to claim 10, wherein the glass substrate when subjected to a heat treatment at 500° C. for 1 hour has a thermal shrinkage of 20 ppm or less.

18: The method for manufacturing a glass substrate according to claim 11, wherein the glass substrate when subjected to a heat treatment at 500° C. for 1 hour has a thermal shrinkage of 20 ppm or less.

19: The method for manufacturing a glass substrate according to claim 12, wherein the glass substrate when subjected to a heat treatment at 500° C. for 1 hour has a thermal shrinkage of 20 ppm or less.

20: The method for manufacturing a glass substrate according to claim 2, wherein the glass substrate has a thickness of 0.01 mm to 1 mm.
